(19) United States
(12) Patent Application Publication
(10) Pub. No.: US 2025/0240579 A1
(43) Pub. Date: Jul. 24, 2025

(54) HEARING DEVICE AND METHOD FOR SIGNAL PROCESSING IN A HEARING DEVICE

(71) Applicant: Sivantos Pte. Ltd., Singapore (SG)

(72) Inventors: Manuel BUSCH, Erlangen (DE); Thomas PILGRIM, Erlangen (DE); Oliver DRESSLER, Erlangen (DE)

(21) Appl. No.: 19/036,304

(22) Filed: Jan. 24, 2025

(30) Foreign Application Priority Data
Jan. 24, 2024 (DE) 10 2024 200 642.4

(51) Int. Cl. H04R 25/00

(52) U.S. Cl. CPC H04R 25/505; H04R 2430/01; H04R 2430/03

(57) ABSTRACT

A hearing device includes an input converter, a signal processing unit and an output converter. The signal processing unit has a filter bank for dividing an input signal into a plurality of signal components in different frequency bands, a processing unit for processing the signal components, and a synthesis unit for synthesizing the processed signal components into an output signal. In order to limit the level of an output signal, a level detector is disposed upstream of the synthesis unit and is configured to determine a signal level based on the signal components and to output a level signal. A level limiter, at which the level signal is transmitted, is disposed downstream of the synthesis unit and is configured to limit the level of the output signal in dependence on the level signal. A method for signal processing in a hearing device is also provided.

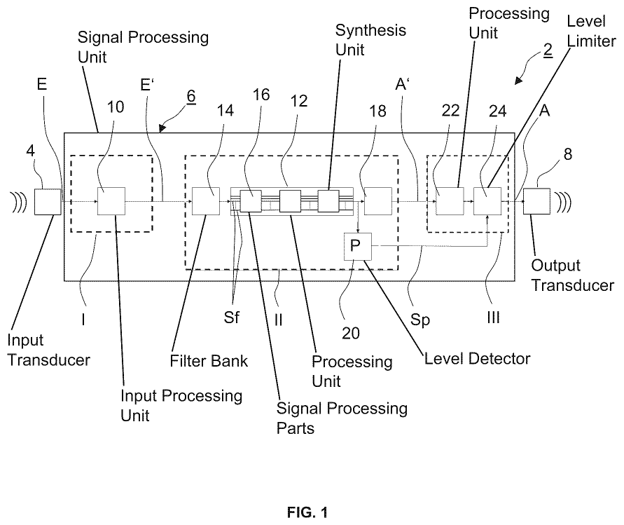

### CROSS-REFERENCE TO RELATED APPLICATION

This application claims the priority, under 35 U.S.C. § 119, of German Patent Application DE 10 2024 200 642.4, filed Jan. 24, 2024; the prior application is herewith incorporated by reference in its entirety.

### FIELD AND BACKGROUND OF THE INVENTION

The invention relates to a hearing device with an input transducer, a signal processing unit and an output transducer, wherein the signal processing unit has a filter bank for dividing an input signal into signal components in a plurality of different frequency bands, a processing unit for processing the signal components and a synthesis unit for synthesizing the processed signal components into an output signal. The invention also relates to a method for signal processing.

Such a hearing device and method can be found in European Patent EP 2 389 773 B1. That prior art as well as the present invention deal with the problem that with high input signal levels, i.e., with loud sound sources, the signal processing in the hearing device can result in too high a signal level being output at the end of the signal processing, so that the signal output to the user is perceived as unpleasant by the user. High signal levels also lead to high energy requirements and high current peaks when the electrical signal is converted into an acoustic signal for the user. That in turn can impair the power supply and lead to voltage dips, for example, which can cause the hearing device to malfunction.

According to European Patent EP 2 389 773 B1, a signal level of an electrical input signal is determined before the input signal is fed to a filter bank where it is divided into different signal components in different frequency bands (frequency channels). In particular, momentary loud noises, so-called transients, are detected within the input signal. Depending on whether transients are detected, a calculation is made in the individual frequency bands (frequency channels) and, if necessary, an amplification factor is adjusted. The various signal components of the different channels are then combined in a summing unit and provided as an electrical output signal, which is then converted into an acoustic output signal in an output converter.

### SUMMARY OF THE INVENTION

It is accordingly an object of the invention to provide a hearing device and a method for signal processing in a hearing device, which overcome the hereinafore-mentioned disadvantages of the heretofore-known devices and methods of this general type and which address the problem of providing improved signal limiting for loud input signals, in particular in the presence of the aforementioned transients.

With the foregoing and other objects in view there is provided, in accordance with the invention, a hearing device, comprising an input transducer, a signal processing unit and an output transducer, wherein the signal processing unit has a filter bank for dividing an input signal into a plurality of signal components in different frequency bands and thus into different channels, a processing unit for processing the signal components, and a synthesis unit for synthesizing the processed signal components into an output signal. The output signal is then transmitted at least indirectly to the output converter. The signal processing unit also has a level detector, which is configured to determine a signal level based on the signal components and to output a level signal. The level detector is disposed upstream of the synthesis unit. Furthermore, a level limiter is provided to which the level signal is transmitted and which is configured to limit the level of the output signal in dependence on the level signal.

With the objects of the invention in view, there is also provided a method for signal processing, in particular in such a hearing device, in which method:
an input signal is divided into a plurality of signal components in different frequency bands,
the signal components are processed,
the processed signal components are combined to form an output signal,
a signal level is determined on the basis of the signal components and a level signal is generated on this basis, and
a level of the output signal is limited on the basis of the level signal.

It should be emphasized that the signal level is determined on the basis of the signal components and therefore only after the filter bank. This measure makes it possible to determine the signal level and thus whether signal limiting is required only after at least some steps in the signal processing have already been carried out, so that a more precise determination and estimation can be made as to whether the level in the output signal is too high.

It should also be emphasized that the level limiter is disposed downstream of the synthesis unit and acts on the combined output signal from the processed signal components. The signal limiting is therefore broadband in the sense that the signal limiter acts on the combined, assembled output signal and not just on individual frequency bands. This prevents signal distortion due to different frequency-specific and therefore channel-specific amplification factors.

The level limiter is disposed downstream in relation to a signal processing path and therefore with a time delay in signal processing compared to the level detector. Taking into account that a certain processing time is required for level detection, this ensures that the level limiter is activated in good time. The inherent delay in (further) signal processing between the level detector and the level limiter is therefore utilized in a suitable manner in order to reliably limit the level when the high level is present. Overall, this decouples the level determination from the level limitation in terms of time.

The signal processing unit is in particular a digital signal processing unit, which is specifically constructed as a digital signal processor. In the present case, a filter bank is generally understood to be a processing unit which divides the electrical input signal fed to the signal processing unit into a plurality of frequency bands and thus into a plurality of frequency channels, wherein a signal component is analyzed and processed in each channel before the various signal components are reassembled.

The processing unit for processing the signal components therefore has a channel-specific processing unit for each frequency band and therefore for each frequency channel. Each of these channel-specific processing units typically has a plurality of channel-specific signal processing parts, for example channel-specific filters or channel-specific amplifier parts.

The filter bank usually transforms the input signal from a time domain to a frequency domain. The signal processing within the processing unit and thus the processing of the signal components therefore takes place in the frequency domain.

In general, the (electrical) input signal is first provided to the signal processing unit in the time domain, which is then transformed into the frequency domain by the filter bank. Lastly, the synthesis unit converts the signal from the frequency domain to the time domain. The output signal is therefore provided in the time domain downstream of the synthesis unit.

The arrangement of the level detector before the synthesis unit and the level limiter after the synthesis unit makes use of the fact that a certain processing time (delay) is required for the transformation from the frequency domain to the time domain, which is utilized for the level determination and especially to ensure that the level limitation is carried out reliably at the desired time.

In a preferred configuration, the level detector is disposed downstream of at least one signal processing part of the processing unit. This ensures that at least one and preferably a plurality of signal processing steps have already taken place within the processing unit, and thus in particular within the processing in the frequency domain, before the level determination is carried out.

In a preferred embodiment, one of these signal processing parts is a (channel-specific) amplifier part and the level determination only takes place downstream of such a channel-specific amplifier part.

Overall, this ensures that the signal level is determined on the basis of signal components that have already been processed, so that the most reliable estimate and determination possible can be made as to whether the output signal is likely to be too high.

Preferably, the level detector is disposed directly upstream of the synthesis unit. In this respect, the level detector is disposed downstream of the complete signal processing of the signal components. The level detector is therefore disposed downstream of the last signal processing part of the processing unit.

In a preferred embodiment, the level limiter is disposed downstream of an output processing unit, which is configured to process the output signal emitted by the synthesis unit. This output processing unit is generally a signal processing unit downstream of the synthesis unit and in particular carries out signal processing of the already assembled electrical output signal. As part of this output signal processing unit, the signal is filtered and/or scaled in the time domain, for example.

In a preferred development, the level detector and the level limiter are directly connected to each other, so that the level signal is transmitted directly from the level detector to the level limiter during operation. Directly connected to each other or direct transmission means that no further processing units for signal processing are attached to the signal path for the level signal; in particular, there is no signal delay due to the direct and immediate connection. The level detector is therefore directly connected to the level limiter by a direct, simple signal line, for example a conductor track. This ensures the fastest possible signal transmission to the level limiter.

In a preferred development, an input signal processing unit is also disposed upstream of the filter bank and is configured to process the input signal upstream of the filter bank. In particular, initial signal processing takes place in the time domain before the signal is divided into the various frequency bands. For example, filtering and/or scaling takes place in the time domain as part of this input signal processing unit.

Preferably, therefore, additional signal processing steps for the respective overall signal in the time domain are carried out both on the input side and on the output side of the processing unit and thus before and after the signal processing in the frequency domain.

Preferably, the level detector and the level limiter are configured in such a way that the level signal correlates with the signal level and that, in particular after a limit value for the signal level is exceeded, the level of the output signal is increasingly limited as the signal level increases. In this case, the level signal therefore also contains information about the level of the signal level determined by the level detector. In particular, a continuous adjustment of the limitation is provided or, alternatively, an adjustment of the limitation in discrete steps.

According to an alternative exemplary embodiment, a fixed, predefined limitation, in particular a fixed limitation factor, is set, for example, once a limit value for the signal level is exceeded.

The determination of a signal level based on the channel-specific signal components in the frequency range is known in principle. Typically, the individual signal components in the various channels are analyzed and evaluated for this purpose. In particular, for example, a channel-specific signal level is determined in each case and this is checked for exceeding a limit value, in particular a channel-specific limit value. The level detector has a channel-specific level detector for each channel, for example.

A level signal to limit the level of the output signal is emitted, for example, as soon as the channel-specific limit value is exceeded in a channel.

In a preferred embodiment, the level detector is configured to estimate a broadband signal level on the basis of the signal components. This is understood to mean that a common, expected signal level is determined on the basis of a plurality of and in particular all signal components, which is present in the assembled output signal after the synthesis unit and before the level limiter and in particular before the output signal processing unit.

Other features which are considered as characteristic for the invention are set forth in the appended claims.

Although the invention is illustrated and described herein as embodied in a hearing device and a method for signal processing in a hearing device, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE FIGURES

The FIGURE of the drawing is a simplified block diagram showing an example of signal processing in a hearing device according to an exemplary embodiment of the invention.

### DETAILED DESCRIPTION OF THE INVENTION

Referring now in detail to the single FIGURE of the drawing, there is seen a hearing device 2 constructed in particular as a hearing aid, which is constructed and configured to compensate for user-specific hearing impairments. Such a hearing device 2 is adapted to user-specific hearing defects of a particular user by an adaptation process, for example at a hearing device acoustician. For this purpose, the values of various setting parameters are suitably adjusted.

The hearing device 2 generally has an input transducer 4, a digital signal processing unit 6 and an output transducer 8. An electrical, digital input signal E is generally provided at the input of the signal processing unit 6 via the input converter 4. This digital input signal E is processed by the signal processing unit 6 and made available at the output of the signal processing unit 6 as a digital output signal A and transmitted to the output converter 8.

The input transducer 4 and/or the output transducer 8 are generally, but not necessarily, electro-acoustic transducers that convert an acoustic signal into an electrical signal and vice versa. In particular, the input transducer 4 is a microphone and the output transducer 8 is a receiver/speaker.

In the exemplary embodiment shown, the input signal E is first subjected to initial signal processing in an input processing unit 10. This first signal processing takes place in the time domain.

There is disposed, downstream, a processing unit 12, in which signal processing takes place in the frequency domain. For this purpose, the processing unit 12 has a filter bank 14 on the input side, which divides the input signal E, in particular the processed input signal E′ provided by the input processing unit 10, into a plurality of signal components Sf in different frequency bands or frequency channels. A respective frequency channel is shown in the FIGURE by a respective line within the processing unit 12. Frequency-specific or channel-specific processing of the input signal E, E′ in the frequency range therefore takes place within the processing unit 12.

The processing unit 12 itself in turn has a plurality of signal processing parts 16, which apply various signal processing functions to the signal. In particular, one of these signal processing parts 16 is configured as an amplifier part. A respective signal processing part 16 is usually divided into preferably mutually identical channel-specific signal processing parts.

A synthesis unit 18 is disposed downstream of the processing unit 12 and the various signal components Sf are combined again in the aid synthesis unit to form a common output signal A, A′. The output signal emitted by the synthesis unit is provided with the reference sign A′.

The processing unit 12 also has a level detector 20, which is configured to determine a signal level P, in particular a broadband signal level. Based on the signal level P determined by the level detector 20, it emits a level signal Sp.

In the exemplary embodiment, the output signal A′ emitted by the synthesis unit 18 is transmitted to an output processing unit 22, in which further signal processing, now again in the time domain, takes place.

In the FIGURE, three dashed areas I, II, III are shown within the signal processing unit, wherein the input-side area I and the output-side area III mark the signal processing in the time domain and the area II disposed in between marks the signal processing in the frequency domain.

A level limiter 24 is disposed downstream of the output processing unit 22. In particular, this is part of a power amplifier, not shown in detail therein. The level signal Sp is transmitted directly from the level detector 20 to the level limiter 24. If necessary, the level limiter 24 limits the level of the output signal A provided at the output of the signal processing unit 6 and transmitted to the output converter 8.

The output signal A is then converted by the output transducer 8, in particular a loudspeaker, preferably into an acoustic output signal and presented to the user.

The level detector 20 determines a broadband signal level P on the basis of a plurality of the signal components Sf, in particular on the basis of all signal components Sf. This is generally a measure of a signal level to be expected in the output signal A′ emitted by the processing unit 12 at its output.

In order to determine the signal level P, channel-specific signal levels of the individual signal components Sf are determined and merged to form the signal level P.

The broadband signal level in the frequency range is generated in particular by adding the linear signal powers (partial powers) of all frequency bands (magnitude squared of the signal components Sf). Preferably, a correction factor is applied to each partial power with a preferably constant band overlap between the partial bands at the output of the filter bank. After addition, the broadband level is determined, for example, by logarithmizing the total linear signal line. This procedure is also known in the technical literature as a “modified periodogram.”

If the signal level P determined in this way is above a predefined, possibly user-specific limit value, the level signal Sp is sent to the level limiter 24 as an indication that the limit value has been exceeded.

In particular, the level signal Sp correlates with the determined signal level P, i.e., it contains information about the actual level of the determined signal level P. The limitation performed by the level limiter 24, when the limit value is exceeded, correlates with the signal level P, i.e., the limitation increases continuously as the signal level P increases.

Overall, this provides a suitable, reliable and fast limitation of the level of the output signal A in the event of transients or a high input level in general.

The following is a summary list of reference numerals and the corresponding structure used in the above description of the invention:
2 hearing device
4 input converter
6 signal processing unit
8 output converter
10 input processing unit
12 processing unit
14 filter bank
16 signal processing part
18 synthesis unit
20 level detector
22 output processing unit
24 level limiter
E input signal
E′ input signal at the input of the processing unit 12
A output signal
A′ output signal at the output of the processing unit 12
Sf signal component
Sp level signal
I, III signal processing in the time domain
II signal processing in the frequency domain

1. A hearing device, comprising:
an input transducer and an output transducer;
a signal processing unit having a filter bank for dividing an input signal into a plurality of signal components in different frequency bands, a processing unit for processing the plurality of signal components, and a synthesis unit for synthesizing the processed signal components into an output signal;
a level detector disposed upstream of said synthesis unit, said level detector configured to determine a signal level based on the plurality of signal components and to output a level signal; and
a level limiter disposed downstream of said synthesis unit, said level limiter receiving the level signal and configured to limit a level of the output signal in dependence on the level signal.

2. The hearing device according to claim 1, wherein said processing unit has at least one signal processing part, and said level detector is disposed downstream of said at least one signal processing part.

3. The hearing device according to claim 2, wherein said level detector is disposed directly upstream of said synthesis unit.

4. The hearing device according to claim 1, which further comprises an output processing unit configured to process the output signal provided by said synthesis unit, said level limiter disposed downstream of said output processing unit.

5. The hearing device according to claim 1, wherein said level detector and said level limiter are directly connected to each other for direct transmission of the level signal.

6. The hearing device according to claim 1, which further comprises an input processing unit disposed upstream of said filter bank, said input processing unit configured to process the input signal upstream of said filter bank.

7. The hearing device according to claim 1, wherein said level detector and said level limiter are configured to correlate the level signal with the signal level, and the level of the output signal is increasingly limited as the signal level increases.

8. The hearing device according to claim 1, wherein said level detector is configured to estimate a broadband signal level based on the plurality of signal components.

9. A method for signal processing in a hearing device, the method comprising:
dividing an input signal into a plurality of signal components in different frequency bands;
processing the signal components;
combining the processed signal components to form an output signal;
determining a signal level based on the plurality of signal components and generating a level signal based on the signal level; and
limiting a level of the output signal based on the level signal.

10. The method according to claim 9, which further comprises determining the signal level immediately before combining the signal components.
